(19) United States
(12) Patent Application Publication
(10) Pub. No.: US 2026/0162650 A1
(43) Pub. Date: Jun. 11, 2026

(54) DIALOGUE LEARNING APPARATUS, RESPONSE AUDIO GENERATION APPARATUS, DIALOGUE LEARNING METHOD, RESPONSE AUDIO GENERATION METHOD AND PROGRAM

(71) Applicant: NTT, Inc., Tokyo (JP)

(72) Inventors: Kenichi FUJITA, Tokyo (JP); Yusuke IJIMA, Tokyo (JP); Hiroyuki TODA, Tokyo (JP)

(73) Assignee: NTT, Inc., Tokyo (JP)

(21) Appl. No.: 18/710,245

(22) PCT Filed: Nov. 17, 2021
(86) PCT No.: PCT/JP2021/042265

§ 371 Date: May 15, 2024

(51) Int. Cl. G10L 15/06; G10L 15/02

(52) U.S. Cl. CPC G10L 15/063; G06F 16/3344; G06F 16/35; G06F 18/23; G06F 18/2325; G06F 40/284; G10L 13/02; G10L 13/06; G10L 15/02; G10L 15/16; G10L 15/1822; G10L 19/032; G10L 2019/0001

(57) ABSTRACT

A dialogue learning device comprising: a dialogue data acquisition unit configured to acquire dialogue data including a dialogue context indicating text of a dialogue and speech data of a response sentence of the dialogue; an acoustic feature value calculation unit configured to calculate an acoustic feature value on the basis of the speech data; and a dialogue learning unit configured to learn a dialogue generation model for generating a dialogue on the basis of the dialogue context and data indicating the calculated acoustic feature value.

### TECHNICAL FIELD

The present invention relates to a dialogue learning device, a response speech generation device, a dialogue learning method, a response speech generation method, and a program.

### BACKGROUND ART

In the field of dialogue generation, a dialogue generation model for learning using dialogue pair data has been proposed. For example, NPL 1 discloses a technique of generating a response sentence for a text dialogue context using a DNN model that performs learning using a large amount of dialoque pair data. The DNN model is used to generate a speech response sentence by converting an output response sentence into speech using speech synthesis.

### CITATION LIST

### Non Patent Literature

[NPL 1] Roller, Stephen, et al.: Recipes for Building an Open-Domain Chatbot, the 16th Conference of the European Chapter of the Association for Computational Linguistics, 2021

### SUMMARY OF INVENTION

### Technical Problem

So far, in order to generate a speech response sentence, speech has been given by performing speech synthesis on a text response sentence generated by a dialogue model. However, since textualization is performed in the middle of this, information about how to speak obtained from a series of text needed for generating natural responses is missing. Thus, there is a problem that generation of sufficiently natural speech expressions that include hesitation expressions peculiar to spoken language corresponding to a context of a dialogue is difficult.

An object of the disclosed technology is to make a speech response sentence more natural.

### Solution to Problem

A disclosed technology is a dialogue learning device including: a dialogue data acquisition unit configured to acquire dialogue data including a dialogue context indicating text of a dialogue and speech data of a response sentence of the dialogue; an acoustic feature value calculation unit configured to calculate an acoustic feature value on the basis of the speech data; and a dialogue learning unit configured to learn a dialogue generation model for generating a dialogue on the basis of the dialogue context and data indicating the calculated acoustic feature value.

### Advantageous Effects of Invention

A speech response sentence can be expressed more naturally.

### BRIEF DESCRIPTION OF DRAWINGS

FIG. 1 is a diagram showing a functional configuration example of a dialogue learning device according to Example 1 of the present embodiment.

FIG. 2 is a flowchart showing an example of a flow of learning processing according to Example 1 of the present embodiment.

FIG. 3 is a diagram showing a functional configuration example of a response speech generation device.

FIG. 4 is a flowchart showing an example of a flow of response voice generation processing.

FIG. 5 is a diagram showing an example of a dialogue context.

FIG. 6 is a diagram for explaining a codebook generation method.

FIG. 7 is a first diagram for explaining a codebook using method.

FIG. 8 is a second diagram for explaining the method for using the codebook.

FIG. 9 is a diagram showing a functional configuration example of a dialogue learning device according to Example 2 of the present embodiment.

FIG. 10 is a flowchart showing an example of a flow of learning processing according to Example 2 of the present embodiment.

FIG. 11 is a diagram showing a functional configuration example of a dialogue learning device according to Example 3 of the present embodiment.

FIG. 12 is a diagram showing a hardware configuration example of a computer.

### DESCRIPTION OF EMBODIMENTS

An embodiment (present embodiment) of the present invention will be described below with reference to the drawings. The embodiment described below is merely an example, and embodiments to which the present invention is applied are not limited to the following embodiment.

### Overview of Present Embodiment

A dialogue learning device according to the present embodiment performs learning of a DNN model for generating a speech response sentence on the basis of a text-based dialogue context and pair data of a speech response sentence therefor. A dialogue speech generation device converts a speech response sentence output by the learned DNN model into an acoustic feature value and quantizes it to generate speech data of the response sentence. Examples 1 to 3 will be described below, as examples of the present embodiment.

Numbers and tiles of references relating to reference techniques and the like of the present embodiment are collectively listed at the end of the present embodiment. In the following description, numbers of related references are shown as “[1]” and the like.

### Example 1

In the present example, an example in which a dialogue learning device performs learning of a DNN model for generating a speech response sentence on the basis of a text-based dialogue context and pair data of a speech response sentence therefor, and a dialogue speech generation device converts a speech response sentence output by the learned DNN model into an acoustic feature value and quantizes it to generate speech data of the response sentence will be described.

### Functional Configuration Example of Dialogue Learning Device According to Example 1

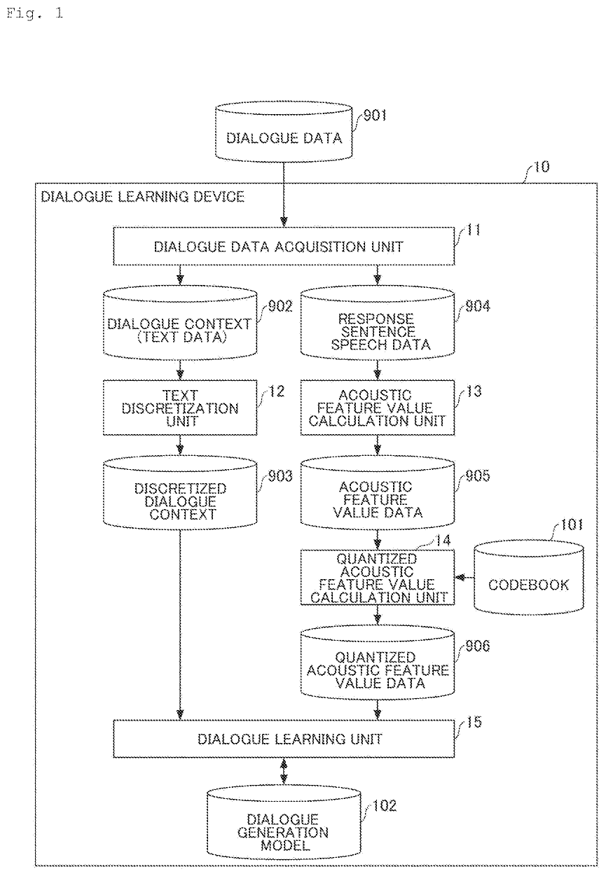

FIG. 1 is a diagram showing a functional configuration example of a dialogue learning device according to Example 1 of the present embodiment.

A dialogue learning device 10 includes a dialogue data acquisition unit 11, a text discretization unit 12, an acoustic feature value calculation unit 13, a quantized acoustic feature value calculation unit 14, and a dialogue learning unit 15.

The dialogue data acquisition unit 11 acquires dialogue data 901. The dialogue data 901 is pair data in which a dialogue context 902, which is a concatenation of pieces of text of several utterances in a past dialog, is associated with speech data of a response sentence following the dialogue (response sentence speech data 904). In order to learn a sufficiently natural dialog, the dialogue data 901 is data including, for example, hundreds of thousands or more pairs. A specific example of the dialogue context 902 will be described later.

The text discretization unit 12 converts the dialogue context 902 included in the dialogue data 901 into an expression (discrete expression) that can be used by the dialogue learning unit 15 and generates a dialogue context that has been discretized (a discretized dialogue context 903). One of discretization methods is a method of tokenizing text with characters or a plurality of consecutive characters on the basis of the frequency of appearance in a sentence using SentencePiece [1] or the like and discretizing the text with its dictionary number.

The acoustic feature value calculation unit 13 calculates an acoustic feature value by performing signal processing (for example, short-time Fourier transform or the like) on the response sentence speech data 904 included in the dialogue data 901. The acoustic feature value calculation unit 13 outputs data (acoustic feature value data 905) indicating the calculated acoustic feature value as a spectrum parameter such as a mel spectrogram.

The quantized acoustic feature value calculation unit 14 converts the acoustic feature value data 905 using a codebook 101 and calculates a quantized acoustic feature value. Details of conversion processing performed by the quantized acoustic feature value calculation unit 14 will be described later. A quantized acoustic feature value calculation unit 14 outputs data (quantized acoustic feature value data 906) indicating the quantized acoustic feature value.

The dialogue learning unit 15 learns a dialogue generation model 102, which is a neural network for generating response speech corresponding to the dialogue context, on the basis of the discretized dialogue context 903 and the quantized acoustic feature value data 906. Since the neural network that forms the dialogue generation model 102 has different input and output lengths, it may be an encoder-decoder type network such as a Transformer [2], for example.

### Operation Example of Dialogue Learning Device According to Example 1

Next, an operation of the dialogue learning device 10 will be described. The dialogue learning device 10 executes learning processing upon receiving a user's operation or the like, or periodically.

It is a flowchart showing an example of a flow of learning processing according to Example 1 of the present embodiment. The dialogue data acquisition unit 11 acquires the dialogue data 901 (step S11). Next, the text discretization unit 12 extracts the dialogue context 902 from the dialogue data 901 (step S12). Then, the text discretization unit 12 discretizes the dialogue context 902 (step S13). The text discretization unit 12 outputs the dialogue context 902 that has been discretized as the discretized dialogue context 903.

Next, the acoustic feature value calculation unit 13 extracts the response sentence speech data 904 from the dialogue data 901 (step S14). Then, the acoustic feature value calculation unit 13 calculates the acoustic feature value from the response sentence speech data (step S15).

Subsequently, the quantized acoustic feature value calculation unit 14 calculates the quantized acoustic feature value from the acoustic feature value data indicating the acoustic feature value calculated by the acoustic feature value calculation unit 13 (step S16). The quantized acoustic feature value calculation unit 14 outputs data indicating the calculated quantized acoustic feature value as the quantized acoustic feature value data 906.

Then, the dialogue learning unit 15 learns the dialogue generation model 102 on the basis of the discretized dialogue context 903 and the quantized acoustic feature value data 906 (step S17). Specifically, the dialogue learning unit 15 updates model parameters of the dialogue generation model 102 by machine learning.

As described above, the dialogue learning device 10 learns the dialogue generation model 102. Next, a response speech generation device that generates response speech using the learned dialogue generation model 102 will be described.

### Functional Configuration Example of Response Speech Generation Device

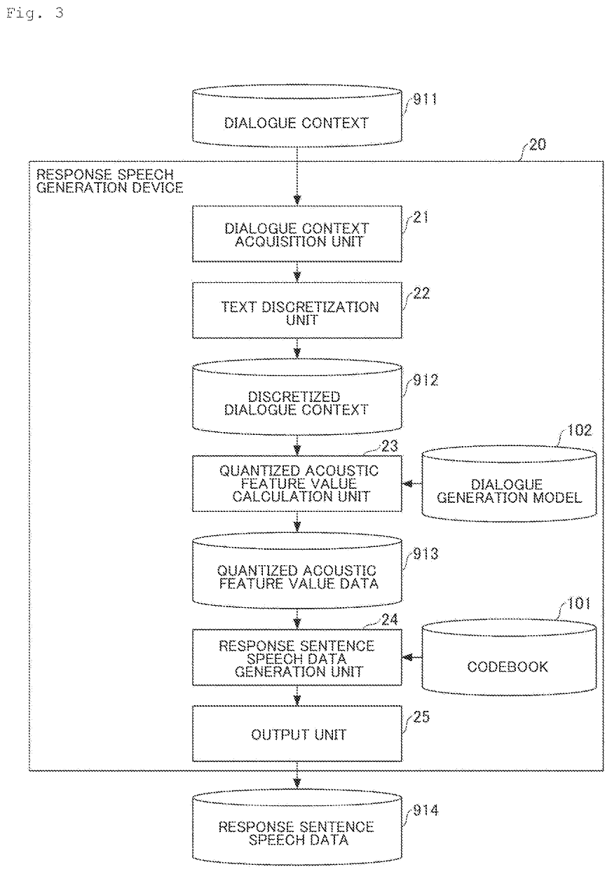

FIG. 3 is a diagram showing a functional configuration example of the response speech generation device. The response speech generation device 20 includes a dialogue context acquisition unit 21, a text discretization unit 22, a quantized acoustic feature value calculation unit 23, a response sentence speech data generation unit 24, and an output unit 25.

The dialogue context acquisition unit 21 acquires a dialogue context 911 serving as a target for which response speech is generated. A format of the dialogue context 911 is the same as that of the dialogue context 902 included in the dialogue data 901 used for learning performed by the dialogue learning device 10.

The text discretization unit 22 discretizes the dialogue context 911 to generate a discretized dialogue context 912. A function of the text discretization unit 22 is the same as that of the text discretization unit 12 of the dialogue learning device 10.

The quantized acoustic feature value calculation unit 23 generates data (quantized acoustic feature value data 913) indicating a quantized acoustic feature value from the discretized dialoque context 912 on the basis of the learned dialogue generation model 102. The generated quantized acoustic feature value data 913 is the same as the quantized acoustic feature value data 906 generated by the quantized acoustic feature value calculation unit 14 of the dialogue learning device 10.

The response sentence speech data generation unit 24 generates speech data indicating a response sentence (response sentence speech data 914) using the codebook 101 on the basis of the quantized acoustic feature value data 913.

The output unit 25 outputs the response sentence speech data 914 to an acoustic device such as a speaker or other data processing device or the like.

### Operational Example of Response Speech Generation Device

Next, operations of the response speech generation device 20 will be described. The response speech generation device 20 executes response speech generation processing in accordance with a user's operation or the like.

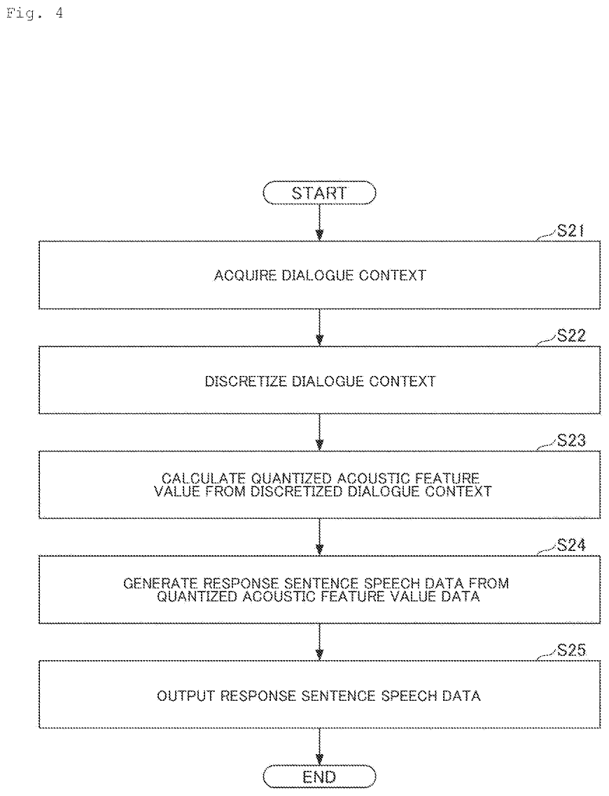

FIG. 4 is a flowchart showing an example of a flow of the response speech generation processing. The dialogue context acquisition unit 21 acquires the dialogue context 911 (step S21). The text discretization unit 22 discretizes the dialogue context 911 (step S22). The text discretization unit 22 outputs the dialogue context 911 that has been discretized as the discretized dialogue context 912.

Next, the quantized acoustic feature value calculation unit 23 calculates the quantized acoustic feature value from the discretized dialogue context 912 (step S23). Here, the quantized acoustic feature value calculation unit 23 calculates the quantized acoustic feature value indicating a speech of an appropriate response sentence using, for example, the learned dialogue generation model 102 obtained by the dialogue learning device 10 or the like. Then, the quantized acoustic feature value calculation unit 23 outputs data indicating the calculated quantized acoustic feature value as the quantized acoustic feature value data 913.

The response sentence speech data generation unit 24 generates the response sentence speech data 914 from the quantized acoustic feature value data 913 (step S24). The output unit 25 outputs the response sentence speech data 914 (step S25).

### Example of Dialogue Context

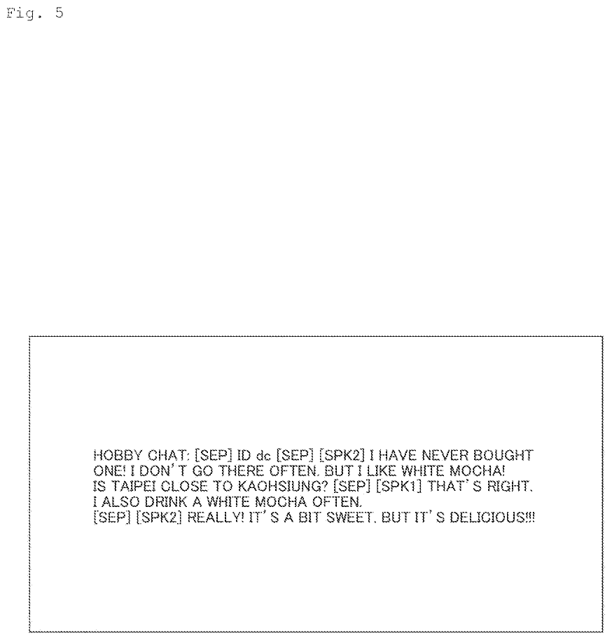

FIG. 5 is a diagram showing an example of the dialogue context. The dialogue context 902 or the dialogue context 911 is obtained by adding separators such as [SEP], speaker information such as [SPK1], and the like to text for several utterances in a dialogue and connecting them to each other.

### Codebook Generation and Using Methods

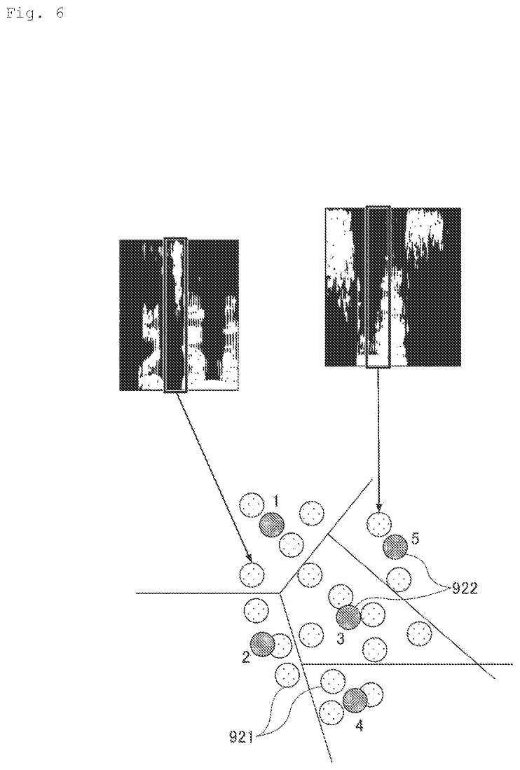

FIG. 6 is a diagram for explaining a codebook generation method. The codebook 101 is generated by the dialogue learning device 10 or another device according to the following method. As a premise, acoustic feature values, which are continuous values, are regarded as a series in which vectors of a certain dimension are arranged. A combination of several continuous vectors is treated as a vector. For example, three continuous vectors each having 80-dimensional acoustic feature values are combined to obtain a 240-dimensional vector.

Then, the dialogue learning device 10 or another device collects the above vectors from a large amount of speech in advance, performs clustering on the vectors, and obtains N clusters. The dialogue learning device 10 or another device may use, for example, an LBG method [3] or the like as a clustering method. Then, the dialogue learning device 10 or another device determines representative points of each cluster from an average value of the clusters and the like and generates the codebook 101 with pairs of cluster numbers of the N clusters and the determined representative points.

In the example of FIG. 6, a representative point 922 represents an average of vectors 921 included in each cluster. A pair of each cluster number and the representative point 922 in the cluster is called a code book.

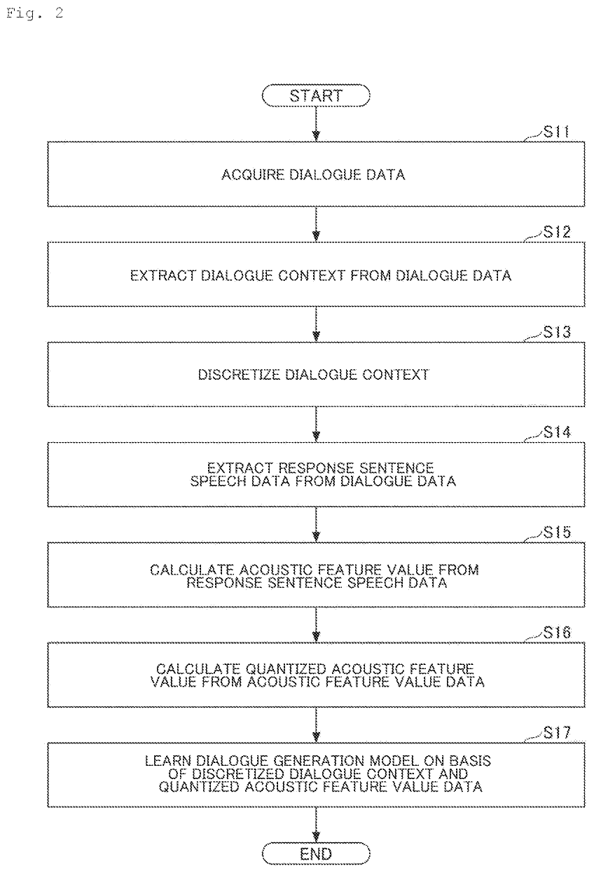

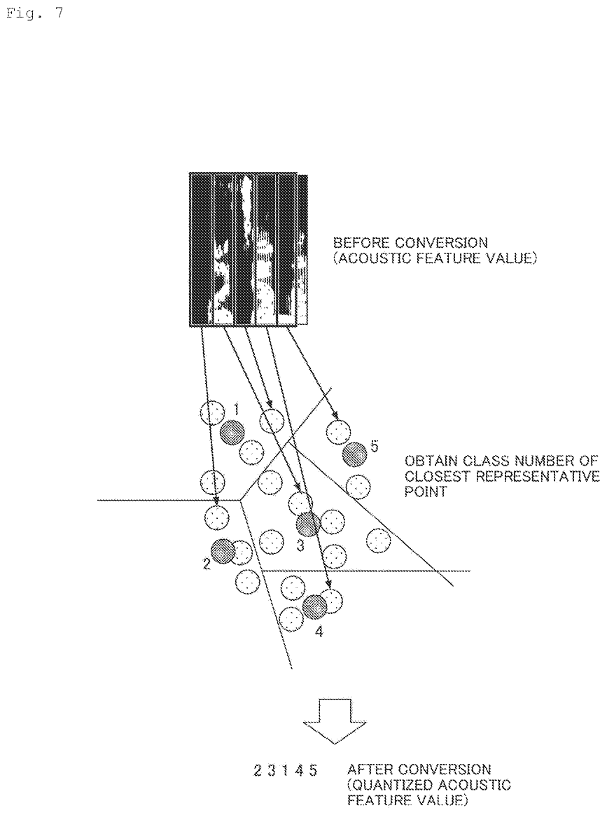

FIG. 7 is a first diagram for explaining a codebook using method. The quantized acoustic feature value calculation unit 14 of the dialogue learning device 10 replaces the acoustic feature value data 905 with a series of cluster numbers (quantized acoustic feature value data 906) using the codebook 101 in step S16 of learning processing shown in FIG. 2. For example, the quantized acoustic feature value calculation unit 14 compares the acoustic feature value data 905 with the codebook 101 and outputs cluster numbers of the representative points arranged in chronological order, which are closest to the acoustic feature value data 905 among the representative points included in the codebook 101, as the quantized acoustic feature value data 906.

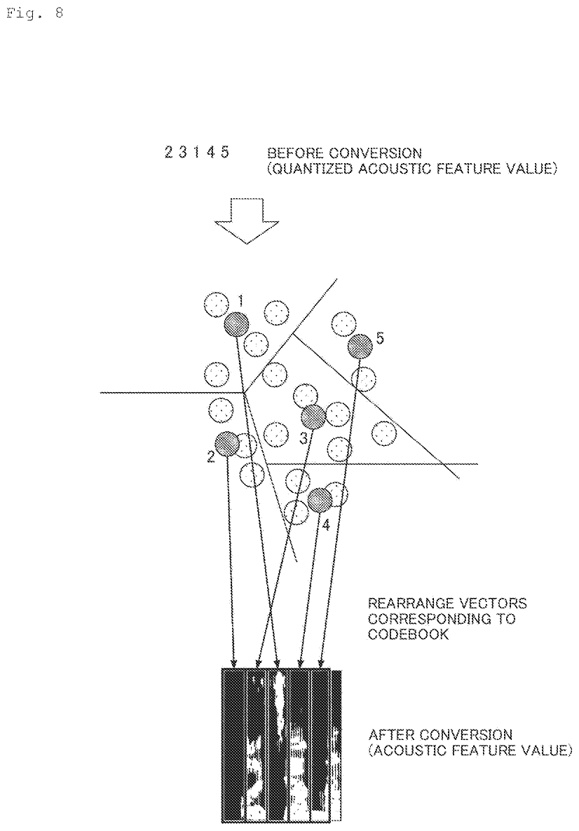

FIG. 8 is a second diagram for explaining the codebook using method. The response sentence speech data generation unit 24 of the response speech generation device 20 obtains data indicating a series of acoustic feature values by rearranging vectors of the acoustic feature values corresponding to respective cluster numbers from a series of cluster numbers indicated in the quantized acoustic feature value data 913 in processing of step S24 of the response speech generation processing shown in FIG. 4.

Then, the response sentence speech data generation unit 24 obtains data indicating synthesized speech by speech waveform generation from data indicating the obtained series of speech feature values. The response sentence speech data generation unit 24 may use, for example, a method described in [4] as the speech waveform generation.

According to the present embodiment, by using the series based on the acoustic feature values as the output of the dialog generation model, learning related to estimation of the (quantized) acoustic feature value data corresponding to the dialogue context is directly performed without going through text. Thus, it is possible to learn a dialogue generation model that enables generation of a more natural response sentence. In addition, by using the dialogue generation model learned in this way, it is possible to generate speech data of the response sentence without going through text, and thus more natural speech expression of the response sentence can be attained.

### Example 2

In Example 1, the text dialogue context and the speech response sentence therefor are used for learning the dialogue generation model, but it may be difficult to obtain a large amount of such pair data that sufficient learning can be attained. In addition, a large amount of learning data is required to improve quality of the dialogue generation model.

Thus, in the present example, pair data of relatively easily available text dialogue context and response sentences (text) is used, and thus an example of converting a response sentence (text) into speech by speech synthesis will be described.

In the following description of Example 2, the description will focus on differences from Example 1, and the same reference numerals as those used in the description of Example 1 will be given to those having the same functional configurations as Example 1, and the description thereof will be omitted.

### Functional Configuration Example of Dialogue Learning Device According to Example 2

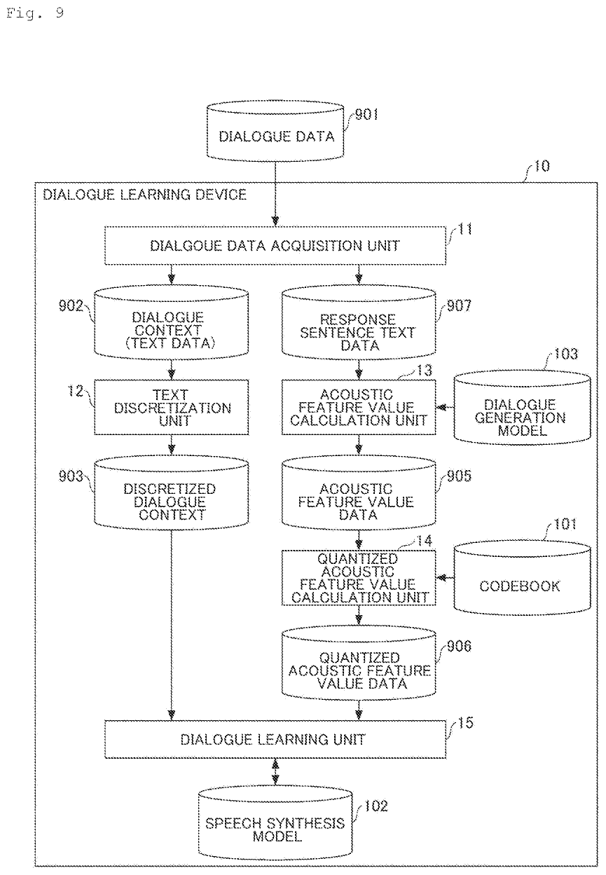

FIG. 9 is a diagram showing a functional configuration example of a dialogue learning device according to Example 2 of the present embodiment. The dialogue data 901 according to the present example is pair data of a dialogue context 902 of text data and text data indicating a response sentence (response sentence text data 907).

In addition, the acoustic feature value calculation unit 13 of the dialogue learning device 10 according to the present example converts the response sentence text data 907 into speech using a speech synthesis model 103 to generate the acoustic feature value data 905.

### Operation Example of Dialogue Learning Device According to Example 2

Next, operations of the dialogue learning device 10 according to the present example will be described.

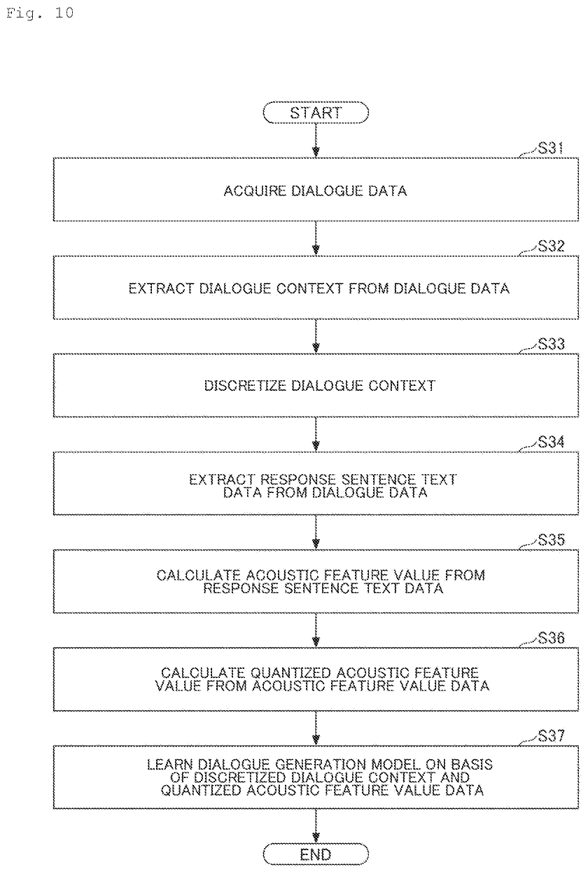

FIG. 10 is a flowchart showing an example of a flow of learning processing according to Example 2 of the present embodiment. Processing from steps S31 to S33 of the learning processing according to the present example is the same as the processing from steps S11 to S13 of the learning processing according to Example 1.

Subsequently to step S33, the acoustic feature value calculation unit 13 extracts the response sentence text data 907 from the dialogue data 901 (step S34). Then, the acoustic feature value calculation unit 13 calculates the acoustic feature value from the response sentence text data 907 by using the speech synthesis model 103 (step S35).

Specifically, the acoustic feature value calculation unit 13 converts the response sentence text data 907 into acoustic feature value data using a speech synthesis method such as “Transformer TTS [5]” in processing of step S35.

Processing from steps S36 to S37 of the learning processing according to the present example is the same as the processing from steps S16 to S17 of the learning processing according to Example 1.

According to the present example, learning of the dialogue generation model is performed using the relatively easily available text-based dialogue data. Accordingly, the accuracy of the dialogue generation model can be improved by using a large amount of learning data.

### Example 3

In the present example, an example of executing the learning processing according to Example 1 or Example 2 on a learned dialogue generation model will be described.

In the following description of Example 3, the description will focus on differences from Example 2, and the same reference numerals as those used in the description of Example 2 will be given to those having the same functional configurations as those of Example 2, and the description thereof will be omitted.

### Functional Configuration Example of Dialogue Learning Device According to Example 3

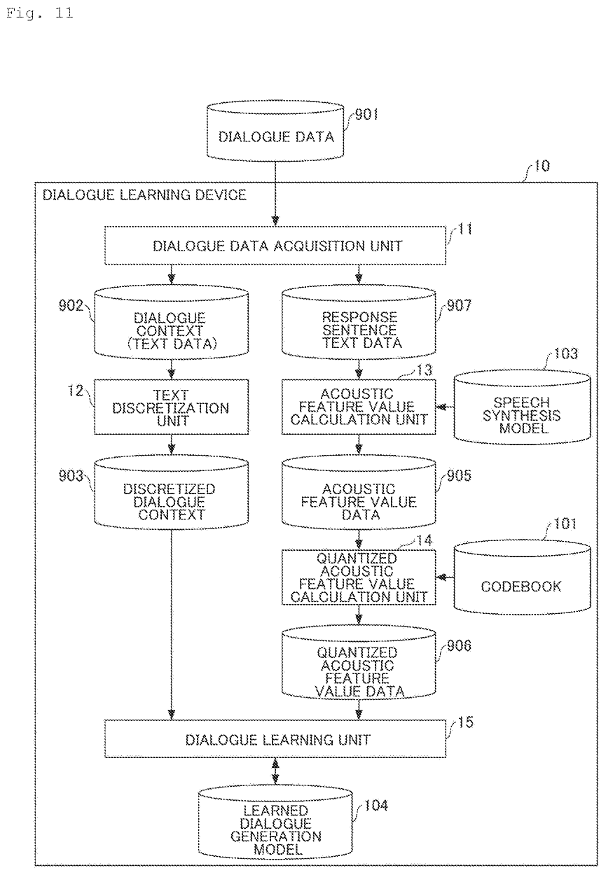

FIG. 11 is a diagram showing a functional configuration example of a dialogue learning device according to Example 3 of the present embodiment. A dialogue learning device 10 according to the present example is different from the dialogue learning device 10 according to Example 2 in that a learning target of the dialogue learning unit 15 is a learned dialogue generation model (learned dialogue generation model 104).

The learned dialogue generation model 104 is a dialogue generation model in which learning is performed using relatively easily available text-based dialogue data. The learned dialogue generation model 104 may be an encoder-decoder type learned DNN model in which learning has been performed using a large amount of text dialogue pair data (for example, tens of thousands to hundreds of millions of pairs).

Accordingly, the learning performed by the dialogue learning device 10 according to the present example functions as fine tuning for the learned dialogue generation model.

Also, although FIG. 11 shows an example in which the dialogue learning device 10 according to Example 2 is applied to the learned dialogue generation model 104, the dialogue learning device 10 according to Example 1 may be applied to the learned dialogue generation model 104.

According to the present example, learning is performed using dialogue pair data of text and speech on the basis of an existing dialogue generation model that acquires knowledge, diversity, and grammatical knowledge needed for dialogue from learning of a large amount of text dialogue pair data. Thus, even if there is only a relatively small amount of pair data of text and speech, it is possible to perform generation of a variety of response sentences using knowledge of the dialogue in the text pair data. cl Hardware Configuration Example According to Present Embodiment

The dialogue learning device 10 or the response speech generation device 20 can be realized, for example, by causing a computer to execute a program describing the processing details described in the present embodiment. Also, the “computer” may be a physical machine or a virtual machine on the cloud. In the case of using a virtual machine, the “hardware” described here is virtual hardware.

The above program can be recorded on a computer-readable recording medium (a portable memory or the like), saved, or distributed. In addition, the above program can also be provided through a network such as the Internet or e-mail.

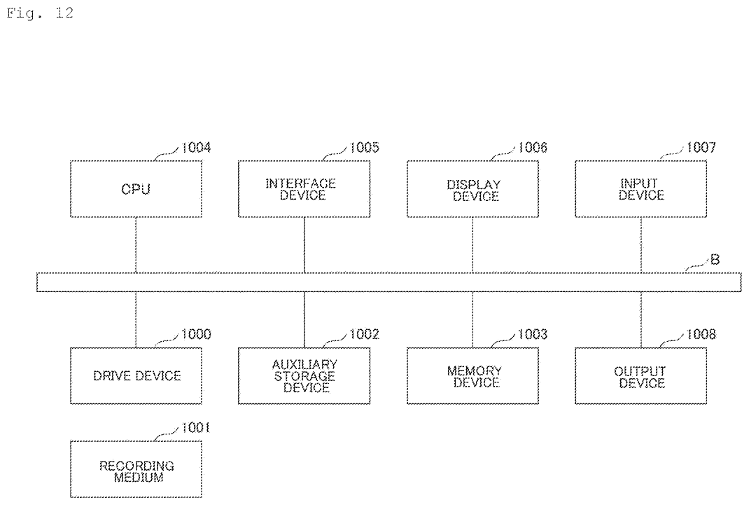

FIG. 12 is a diagram showing a hardware configuration example of the computer. The computer shown of FIG. 12 has a drive device 1000, an auxiliary storage device 1002, a memory device 1003, a CPU 1004, an interface device 1005, a display device 1006, an input device 1007, an output device 1008, and the like, which are connected to each other via a bus B.

A program for realizing processing in the computer is provided by a recording medium 1001 such as, for example, a CD-ROM or a memory card. When the recording medium 1001 in which the program is stored is set in the drive device 1000, the program is installed from the recording medium 1001 through the drive device 1000 to the auxiliary storage device 1002. However, the program does not necessarily need to be installed from the recording medium 1001 and may be downloaded from another computer via a network. The auxiliary storage device 1002 stores the installed program and also stores necessary files, data, and the like.

The memory device 1003 reads and stores the program from the auxiliary storage device 1002 when an instruction to start the program is given. The CPU 1004 realizes functions relating to the device in accordance with the program stored in the memory device 1003. The interface device 1005 is used as an interface for connection to a network. The display device 1006 displays a graphical user interface (GUI) and the like in accordance with the program. The input device 1007 is configured of a keyboard, a mouse, a button, a touch panel, or the like and is used for inputting various operation instructions. The output device 1008 outputs calculation results. Also, the above computer may include a graphics processing unit (GPU) or a tensor processing unit (TPU) instead of the CPU 1004, or may include a GPU or a TPU in addition to the CPU 1004. In that case, processing may be divided and executed in such a way that the GPU or the TPU executes processing that requires special arithmetic operations, and that the CPU 1004 executes other processing.

### REFERENCES

[1]1 Kudo, Taku, and John Richardson, SentencePiece: A simple and language independent subword tokenizer and dokenizer for Neural Text Processing. Proceedings of the 2018 Conference on Empirical Methods in Natural Language Processing: System Demonstrations. 2018.
[2] Vaswani, Ashish, et al. “Attention is all you need. “Advances in neural information processing systems. 2017.
[3] Linde, Y.; Buzo, A.; Gray, R., An Algorithm for Vector Quantizer Design. IEEE Transactions on Communications. 1980
[4] Kong, Zhifeng, et al., Diffwave: A versatile diffusion model for audio synthesis. 2020
[5] Li, Nathan, et al., Neural speech synthesis with transformer network. “Proceedings of the AAAI Conference on Artificial Intelligence. 2019.

### Summary of Embodiment

This specification describes at least the dialogue learning device, the response speech generation device, the dialogue learning method, the response speech generation method, and the program described in at least each of the following items.

### (Item 1)

A dialogue learning device including:
a dialogue data acquisition unit configured to acquire dialogue data including a dialogue context indicating text of a dialogue and speech data of a response sentence of the dialogue;
an acoustic feature value calculation unit configured to calculate an acoustic feature value on the basis of the speech data; and
a dialogue learning unit configured to learn a dialogue generation model for generating a dialogue on the basis of the dialogue context and data indicating the calculated acoustic feature value.

### (Item 2)

The dialogue learning device according to item 1 further including
a quantized acoustic feature value calculation unit configured to calculate a quantized acoustic feature value by clustering on the basis of the calculated acoustic feature value, wherein the dialogue learning unit is configured to learn the dialogue generation model on the basis of the dialogue context and data indicating the quantized acoustic feature value.

### (Item 3)

The dialogue learning device according to item 1 or 2, wherein the dialogue data acquisition unit is configured to acquire dialogue data including the dialogue context and text data of the response sentence of the dialog, and
the acoustic feature value calculation unit is configured to calculate an acoustic feature value on the basis of the text data,

### (Item 4)

The dialogue learning device according to any one of items 1 to 3, wherein
the dialogue learning unit is configured to learn the learned dialogue generation model learned based on the text data based on the basis of the dialogue context and the data indicating the calculated acoustic feature value.

### (Item 5)

A response speech generation device including:
a dialogue context acquisition unit configured to acquire a dialogue context indicating text of a dialogue;
a quantized acoustic feature value calculation unit configured to calculate a quantized acoustic feature value on the basis of the dialogue context using a dialogue generation model for generating a dialog, and
a response sentence speech data generation unit configured to generate speech data indicating a response sentence on the basis of the quantized data indicating the acoustic feature value.

### (Item 6)

A dialogue learning method executed by a dialogue learning device, including:
acquiring dialogue data including a dialogue context indicating text of a dialogue and speech data of a response sentence of the dialogue;
calculating an acoustic feature value on the basis of the speech data; and
learning a dialogue generation model for generating a dialogue on the basis of the dialogue context and data indicating the calculated acoustic feature value.

### (Item 7)

A response speech generation method executed by a response speech generation device, including:
acquiring a dialogue context indicating text of a dialogue;
calculating a quantized acoustic feature value on the basis of the dialogue context using a dialogue generation model for generating a dialogue; and
generating speech data indicating a response sentence on the basis of data indicating the quantized acoustic feature value.

### (Item 8)

A program configured to cause a computer to function as each unit in the dialogue learning device according to any one of items 1 to 4 or a program configured to cause a computer to function as each unit in the response speech generation device according to item 5.

Although the present embodiment has been described above, the present invention is not limited to such a specific embodiment and various modifications and changes can be made within the scope of the gist of the present invention described in the claims.

### REFERENCE SIGNS LIST

10 Dialogue learning device
11 Dialogue data acquisition unit
12 Text discretization unit
13 Acoustic feature value calculation unit
14 Quantized acoustic feature value calculation unit
15 Dialogue learning unit
20 Response speech generation device
21 Dialogue context acquisition unit
22 Text discretization unit
23 Quantized acoustic feature value calculation unit
24 Response sentence speech data generation unit
25 Output unit
1000 Drive device
1001 Recording medium
1002 Auxiliary storage device
1003 Memory device
1004 CPU
1005 Interface device
1006 Display device
1007 Input device
1008 Output device

1. A dialogue learning device comprising:
a dialogue data acquisition unit configured to acquire dialogue data including a dialogue context indicating text of a dialogue and speech data of a response sentence of the dialogue;
an acoustic feature value calculation unit configured to calculate an acoustic feature value on the basis of the speech data; and
a dialogue learning unit configured to learn a dialogue generation model for generating a dialogue on the basis of the dialogue context and data indicating the calculated acoustic feature value.

2. The dialogue learning device according to claim 1 further comprising
a quantized acoustic feature value calculation unit configured to calculate a quantized acoustic feature value by clustering on the basis of the calculated acoustic feature value, wherein
the dialogue learning unit is configured to learn the dialogue generation model on the basis of the dialogue context and data indicating the quantized acoustic feature value.

3. The dialogue learning device according to claim 1, wherein
the dialogue data acquisition unit is configured to acquire dialogue data including the dialogue context and text data of the response sentence of the dialog, and
the acoustic feature value calculation unit is configured to calculate an acoustic feature value on the basis of the text data.

4. The dialogue learning device according to claim 1, wherein
the dialogue learning unit is configured to learn the learned dialogue generation model learned based on the text data based on the basis of the dialogue context and the data indicating the calculated acoustic feature value.

5. A response speech generation device comprising:
a dialogue context acquisition unit configured to acquire a dialogue context indicating text of a dialogue;
a quantized acoustic feature value calculation unit configured to calculate a quantized acoustic feature value on the basis of the dialogue context using a dialogue generation model for generating a dialog, and
a response sentence speech data generation unit configured to generate speech data indicating a response sentence on the basis of the quantized data indicating the acoustic feature value.

6. A dialogue learning method executed by a dialogue learning device, comprising:
acquiring dialogue data including a dialogue context indicating text of a dialogue and speech data of a response sentence of the dialogue;
calculating an acoustic feature value on the basis of the speech data; and
learning a dialogue generation model for generating a dialogue on the basis of the dialogue context and data indicating the calculated acoustic feature value.

7. A response speech generation method executed by a response speech generation device, comprising:
acquiring a dialogue context indicating text of a dialogue;
calculating a quantized acoustic feature value on the basis of the dialogue context using a dialogue generation model for generating a dialogue; and
generating speech data indicating a response sentence on the basis of data indicating the quantized acoustic feature value.

8. (canceled)

9. The dialogue learning method according to claim 6 further comprising
calculating a quantized acoustic feature value by clustering on the basis of the calculated acoustic feature value, wherein
the dialogue generation model is learnt on the basis of the dialogue context and data indicating the quantized acoustic feature value.

10. The dialogue learning method according to claim 6, wherein
acquiring dialogue data including the dialogue context and text data of the response sentence of the dialog, and
calculating an acoustic feature value on the basis of the text data.

11. The dialogue learning method according to claim 6, wherein
the learned dialogue generation model is learnt based on the text data of the dialogue context and the data indicating the calculated acoustic feature value.

12. The response speech generation device according to claim 5, wherein a quantized acoustic feature quantity is calculated from a discretized dialogue context, wherein the quantized acoustic feature quantity indicates speech of an appropriate response sentence.

13. The response speech generation device according to claim 5, wherein a plurality of clusters is generated based on collected speech vectors.

14. The response speech generation device according to claim 13, wherein a representative point representing average of the speech vectors and a cluster number of the plurality of clusters are paired and stored as a codebook.

15. The response speech generation method according to claim 7, wherein acoustic feature data corresponding to the dialogue context is quantized without generating text data.

16. The response speech generation method according to claim 7, comprising:
calculating a quantized acoustic feature quantity from a discretized dialogue context, wherein the quantized acoustic feature quantity indicates speech of an appropriate response sentence.

17. The response speech generation method according to claim 7, wherein a plurality of clusters is generated based on collected speech vectors.

18. The response speech generation method according to claim 17, wherein a representative point representing average of the speech vectors and a cluster number of the plurality of clusters are paired and stored as a codebook.

19. The response speech generation method according to claim 7, wherein acoustic feature data corresponding to the dialogue context is quantized without generating text data.

20. The response speech generation method according to claim 7, wherein a generation model is trained based on a text-speech pair.

21. The response speech generation method according to claim 7, wherein a response sentence text data is extracted from a dialogue data and the acoustic feature amount is calculated from the response sentence text data.
